(19) United States
(12) Patent Application Publication
(10) Pub. No.: US 2010/0088686 A1
(43) Pub. Date: Apr. 8, 2010

(54) PROGRAMMING LANGUAGE WITH EXTENSIBLE SYNTAX

(75) Inventors: David E. Langworthy, Kirkland, WA (US); Bradford H. Lovering, Seattle, WA (US); Donald F. Box, Yarrowpoint, WA (US); Joshua Williams, Seattle, WA (US); Giovanni M. Della-Libera, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/325,753

(22) Filed: Dec. 1, 2008

Related U.S. Application Data
(60) Provisional application No. 61/103,227, filed on Oct. 6, 2008.

(51) Int. Cl. G06F 9/45

(52) U.S. Cl. 717/143

(57) ABSTRACT

The subject disclosure relates to an extensible syntax for a scripting language that allows data intensive applications to be written in a compact, human friendly, textual format, and also according to self-defined syntax within the data intensive applications so that a single compilation unit of a program can support multiple syntaxes. An extensible syntax is provided for M that allows alternate syntaxes to be defined in line and then used in the program so as to accommodate user-defined syntaxes and other pre-existing domain specific languages. In one embodiment, the alternate syntaxes can be defined at pre-designated functional points in the program.

### PRIORITY CLAIM

The present application claims priority to U.S. Provisional Application No. 61/103,227, filed Oct. 6, 2008, entitled “PROGRAMMING LANGUAGE WITH EXTENSIBLE SYNTAX”, the entirety of which is incorporated herein by reference.

### TECHNICAL FIELD

The subject disclosure generally relates to a programming language with extensible syntax within a compilation unit of the programming language in order to accommodate other desired syntax(es) within programs.

### BACKGROUND

By way of background, when a large amount of data is stored in a database, such as when a set of server computers collect large numbers of records, or transactions, of data over long periods of time, other computers and their applications may desire access to that data or a targeted subset of that data. In such case, the other computers can use programs developed from scripting languages to query for desired data, read or write to the data, update the data, or apply any other processing to the data, via one or more operators, such as query operators, via a variety of conventional query languages. The amount of data can be voluminous in such circumstances, and the applications that have evolved for consuming the data become quite data intensive. Writing these data intensive applications in a compact, human friendly, textual format has thus far been a challenge.

Historically, relational databases have evolved for this purpose to organize large numbers of records and fields, and have been used for such large scale data collection, and various database query languages such as the structured query language (SQL) and other domain specific languages have developed, which instruct database management software to retrieve data from a relational database, or a set of distributed databases, on behalf of a querying client or application. Yet, by and large, due to the specific purposes for which such languages were developed and the context in which they were meant to operate, among various domain specific limitations, such languages, in a nutshell, have failed to provide sufficient generality and have elevated the importance of syntactically complex constructs and decreased the importance of intuitive expression.

However, to provide a solution to this problem by constructing a programming language that is generalized and easy to use for data intensive applications, inevitably the very use of that programming language abandons the complex and domain specific syntactical constructs with which many developers have already become accustomed and prefer. This is because the selection of a single language today for development implies using the syntax of that language, and that language only.

By way of further background, when describing data from a specific domain, e.g., systems management, reinsurance, tax code, baseball statistics, patent claims, there is usually a set of terminology and grammatical rules specific to that domain. That set of terminology and grammatical rules are referred to as a “language”. Programming languages have their own built in terminology and grammatical rules too, which are quite particular to the programming languages themselves. As one in the software technology arts can recognize, writing a program in FORTRAN involves writing different source code than writing the same or similar program in C++. Like human languages, there may be, in fact, no way to translate between programs of different languages where one language does not possess certain expressional capabilities of the other language, or vice versa.

In this regard, describing domain specific concepts in a programming language is both verbose and error prone, which motivates the development of “domain specific languages” (DSLs) that are well suited to development within their domain, but not necessarily other domains. Conventionally, DSLs have fallen into two categories: external and internal. An external DSL can be fully customized to a domain's terminology and grammar rules. An internal DSL uses a host programming languages grammar rules and then develops a vocabulary within or on top of those rules. External DSLs are more succinct, but lose many of the benefits of a host programming language and associated tools since they are, by definition, external. An internal DSL retains the benefits of the host language, but is more verbose and is again error prone since construction is subject to the host grammar rules.

In addition, no matter how compact and easy to use a syntax of a language may be, different developers having different backgrounds, experiences, cultures, etc. may conceptually view data differently. For an example of how two different people can “naturally” or conceptually look at data differently, consider that Americans typically write the given name of a person first and the surname second, though some foreign countries perceive the reverse, placing the surname first. Similarly, some countries prefer to list day-month-year, whereas the US prefers month-day-year notations. Thus, whatever syntax is ultimately decided on, there should be flexibility to accommodate a preferred way of viewing and talking about data in programs.

While macro expansion can be used to instantiate a macro into a specific output sequence, are supported in some languages, the syntax for how macros are defined in the language is fixed by the native language, and not customizable to the user's desires.

FIG. 1 generally illustrates a conventional approach to this problem. In a typical compilation chain (ignoring many details), a program 100 is written in some programming language, compiler 110 compiles the program 100 and the result of compilation is object representation 120. In this regard, program 100 has typically adhered to a single syntax. If that syntax is not correct, the program 100 may not compile correctly. However, to achieve multiple syntaxes in program 100, one conventional solution has been to input a separate file 130 external to program 100 that specifies how the compiler 110 should, in essence, replace certain constructs in program 100 so that it appears to the compiler as a single syntax.

However, separation of a program 100 from the definition of its syntax inherently has problems. First, if any of the rules 130 are changed or versioned, program 100 may not work anymore. Second, if the rules 130 become inaccessible or unavailable due to network outage, deletion, move, etc., then the program 100 may not work anymore. Thus, what is desired is a compact programming language for large scale data processing language that does not restrict the syntax that the developer must use, if the developer would prefer to use a variety of syntaxes, and in a way that does not have external dependencies that can break down if modified, deleted, moved, forgotten by the developer, etc.

The above-described background information and deficiencies of current programming languages and corresponding systems are merely intended to provide an overview of some of the background information and problems of conventional programming languages, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

An extensible syntax for a scripting language is provided in various embodiments that allows data intensive applications to be written in a compact, human friendly, textual format, and also according to self-defined syntax within the data intensive applications so that a single compilation unit of a program can support multiple syntaxes. In one embodiment, the scripting language is a declarative programming language, such as the “M” programming language designed by Microsoft, which is well suited to the authoring of data intensive programs. An extensible syntax is provided for M that allows alternate syntaxes to be defined, e.g., in line, and then used in the program so as to accommodate user-defined syntaxes and other-pre-existing domain specific languages. In one embodiment, the alternate syntaxes can be defined at pre-designated functional points in the program.

These and other embodiments are described in more detail below.

### BRIEF DESCRIPTION OF THE DRAWINGS

Various non-limiting embodiments are further described with reference to the accompanying drawings in which:

FIG. 1 illustrates a conventional system that applies external rules to transform programming syntax of a program by a compiler;

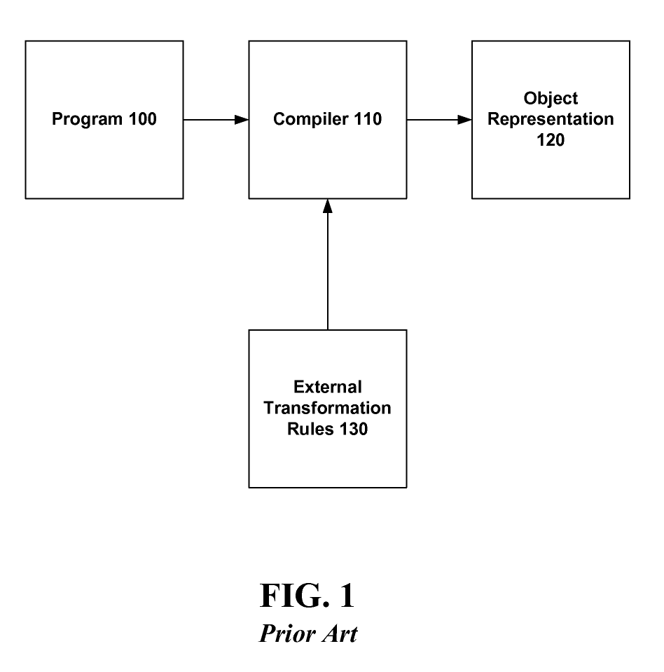

FIG. 2 is a block diagram illustrating the extensible syntax for a programming language as described in one or more embodiments herein;

FIG. 3 is a block diagram illustrating a program having an inline definition of an alternate syntax to a native syntax, which are both used within the program;

FIG. 4 is a block diagram illustrating various pre-defined insertion points for a new syntax in accordance with one or more embodiments;

FIG. 5 is a block diagram illustrating various aspects of a new syntax nested in another new syntax in accordance with one or more embodiments;

FIG. 6 is a block diagram illustrating scoping of new syntax within a program in accordance with one or more embodiments;

FIG. 7 is a flow diagram illustrating an exemplary non-limiting compilation process in accordance with one or more embodiments;

FIG. 8 is a flow diagram illustrating an exemplary non-limiting process for generating object code in accordance with one or more embodiments;

FIG. 9 is an exemplary process chain for a declarative model defined by a representative programming language in accordance with various embodiments;

FIG. 10 is an illustration of a type system associated with a record-oriented execution model;

FIG. 11 is a non-limiting illustration of a type system associated with a constraint-based execution model according to an embodiment of the invention;

FIG. 12 is an illustration of data storage according to an ordered execution model;

FIG. 13 is a non-limiting illustration of data storage according to an order-independent execution model;

FIG. 14 is a block diagram representing exemplary non-limiting networked environments in which various embodiments described herein can be implemented; and

FIG. 15 is a block diagram representing an exemplary non-limiting computing system or operating environment in which one or more aspects of various embodiments described herein can be implemented.

### DETAILED DESCRIPTION

### Overview

As discussed in the background, among other things, conventional systems for achieving multiple syntaxes in a programming language have involved purely external rules and definitions for transforming constructs by the compiler, however, making a program disjoint from its syntactical definitions is a bad idea for a variety of reasons such as those discussed in the background.

In part consideration of limitations of prior attempts, and in part leveraging the advantages of a declarative programming language, such as the M programming language developed by Microsoft (or “M” for short), various non-limiting embodiments of a declarative programming language are described herein having an extensible syntax where the syntax of the programming language is extended within the program itself.

M is a programming language designed by Microsoft that is well suited to author data intensive programs. In various non-limiting embodiments described herein, code can be developed directly to an in-memory representation of the language, or transformed to the in-memory representation from source code. In various non-limiting embodiments, systems, applications and programs can generate and automatically validate code adhering to multiple syntaxes that are defined within the program.

The M Intermediate Representation (MIR) is an in-memory representation of M modules. MIR is a data-oriented object model and is designed for simple construction using object initialization syntax that has a high degree of correspondence to the syntax of an M compilation unit. Types in the MIR consist solely of properties that represent elements of an M compilation unit, with no intrinsic behavior. All behavior (type checking, name resolution, code generation) is implemented as methods that are external to the MIR and accept MIR graphs as input.

In this regard, the M programming language, more details about which can be found below, is a declarative programming language that is well suited to compact and human understandable representation and advantageously includes efficient constructs for creating and modifying data intensive applications, independent of an underlying storage mechanism, whether flash storage, a relational database, RAM, external drive, network drive, etc. “M” is also sometimes called the “D” programming language, although for consistency, references to D are not used herein.

The M programming language is provided as the context for various embodiments set forth herein with respect to M source code, M abstract syntax trees, M graph structures, etc., however, for the avoidance of doubt, it should be understood that the invention is not limited to the M programming language as a native language. Thus, it can be appreciated that the various embodiments described herein can be applied to any declarative programming languages having the same or similar capabilities of M with respect to being able to extend its own syntax within the program itself.

Accordingly, in various non-limiting embodiments, the present invention provides an extensible syntax for a declarative data scripting language, such as the M programming language, so that other syntaxes of other programming languages or user-defined languages can be accommodated within a single program or compilation unit. In this regard, the programming constructs of M can also be represented efficiently as semistructured graph data based on one or more abstract syntax trees generated for a given source code received by a compiler, and advantageously, the source code can be specified according to multiple syntaxes.

The following is an example of the way a Person can be defined in the M programming language as a type with a first and last name, how People can be defined as 1 or more Persons, and how People includes a Person named Serena Williams. For the avoidance of doubt, the “M>>>” is a cursor representation, i.e., an artifact of the scripting environment.

M>>> type Person { First : Text; Last : Text; }
M>>> People : Person*;
M>>> People { { First = “Serena”, Last = “Williams” } }

As a result, stating People per the below in effect asks for the defined Person data to be enumerated thus results in a definition of Josh Williams.

```
M>>> People
{
  {
    First = “Serena”,
    Last = “Williams”
  }
}
```

Similarly, stating People.First per the below in effect asks for the first names of defined Person data to be enumerated, which results in a definition of Serena.

M>>> People.First
{
“Serena”
}

Thus far, only the host domain syntax of the M language is used, but by specifying or importing the following new syntax regarding Person with a language called Contacts:

```
module Contacts {
  language Contacts {
    @{Classification[“String”]}token Name = (‘a’..‘z’ | ‘A’..‘Z’)+;
    interleave Whitespace = ‘ ’ | ‘\r’ | ‘\n’;
    @{Classification[“Keyword”]} token PersonKeyword = “Person:”;
    syntax Person =
      PersonKeyword first:Name last:Name
        => { First { first }, Last { last } };
    syntax Main = p:Person* => People { valuesof(p) };
  }
}
```

Then, the following new expressions are valid, and as one can easily recognize, more intuitive than the M programming language counterparts since humans are used to a domain where people are referred to by their first name and then their last name without other arbitrary syntax intervening. Thus, more Persons can be defined with the Contact language as follows:

Contacts>>> Person: Tiger Woods
Contacts>>> Person: Wayne Gretzky
Contacts>>> Person: Magic Johnson

Then, based on the Person specified in the host domain and the above three people specified in the Contacts language domain, an expression requesting the enumeration of People, such as the following, yields:

```
M>>> People
{
  {
    First = “Serena”,
    Last = “Williams”
  },
  {
    First = “Tiger”,
    Last = “Woods”
  },
  {
    First = “Wayne”,
    Last = “Gretzky”
  },
  {
    First = “Magic”,
    Last = “Johnson”
  }
}
```

More complex expressions over People can be constructed too, such as an expression that requests only those People having a last name with more than 7 letters:

```
M>>> People where value.Last.Count > 7
{
  {
    First = “Serena”,
    Last = “Williams”
  }
}
```

While the above example is a relatively simple example, one can see the power of a language that allows representation within its four corners of other languages and rules. Various embodiments are described in more detail below.

### Extensible Syntax for Data Scripting Language

As mentioned, in various non-limiting embodiments, an extensible syntax for a declarative programming language, such as the M programming language used for illustrative purposes herein (also sometimes referred to as the D programming language), is provided, though the embodiments are not limited to the M language.

In various embodiments, with the Extensible Programming Language, a programming language can extend its own terminology and grammatical rules with the rules from a specific domain (or domains), and such domains can be custom domains defined by a user or pre-existing domains. The benefits are that the succinctness and correctness of an external DSL (or foreign language) can be combined with the features and tooling of a host programming language, by including the foreign language definition in the host program itself.

Thus, the ability to define terminology and grammatical rules is provided within a host programming language for specific domains (a DSL). In this regard, the terminology and grammatical rules for the host programming language can be extended such that a DSL can be used within the same file that declares the new rules of the DSL, which file can be compiled as a self-contained compilation unit. In various embodiments illustrated in more detail below, the host programming language provides the data from the DSL according to a uniform representation, which the host programming language is capable of compiling together with the host source code.

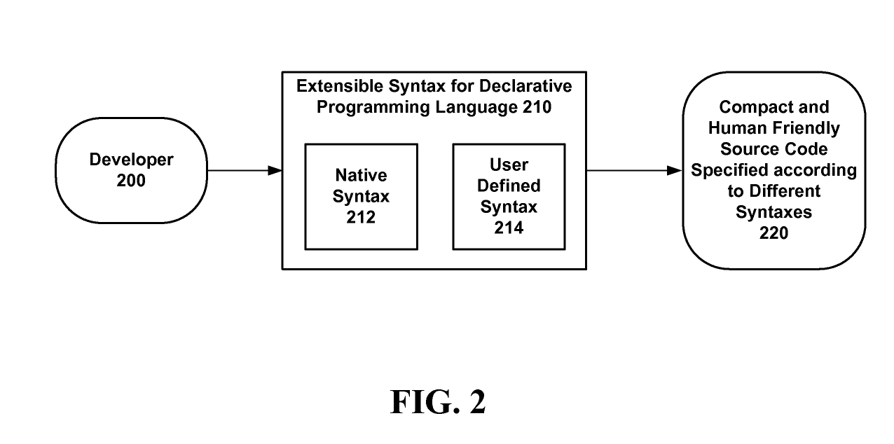

As shown in the general diagram of FIG. 2, a developer 200 can create program code 210 according to a declarative programming language having an extensible syntax. In addition to the native syntax 212 supported by the programming language used for code 210, the user can define a language with different syntax 214, or otherwise specify another pre-existing DSL. As a result, source code 220 can be generated specified according to a compact, human friendly representation (benefit of the native programming language) and according to foreign syntax where desirable as well, providing a great deal of flexibility within a program. Thus, a self modifying grammar is provided for a host programming language to bend the syntax of the host language to user preferred domains or pre-existing DSLs.

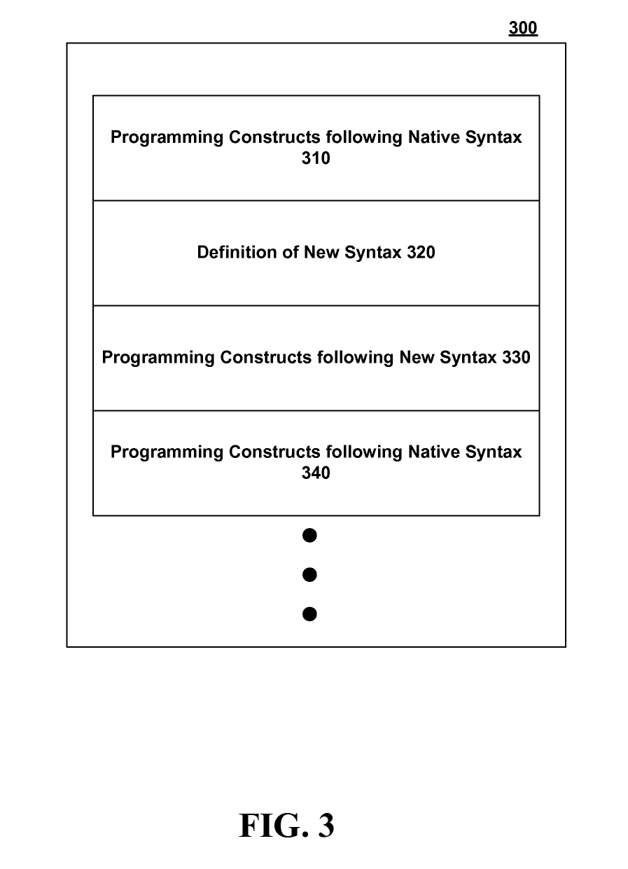

FIG. 3 illustrates a hypothetical program 300 to illustrate the concept. In one file 300, first some programming constructs following the native syntax 310 may appear. Then, a definition of a new syntax 320 may be found. Then, programming constructs following the new syntax 330 can be found, followed by programming constructs in the native language 340 again. The order in which these constructs appear may not be particularly critical in the M programming language and it is interesting that native and new syntaxes can be defined and used within the program itself. A different M program can use other syntaxes, and so on.

In one non-limiting embodiment, the mechanism for implementation includes two phases:

Phase 1: Parse all files and extract new syntax rules then extend host language with these rules.

Phase 2: Parse all files a second time looking for domain specific terminology, then return the results of the parse in a uniform data representation—M semantic graphs.

In various embodiments, the extensible syntax is made manageable by providing a variety of features that make the use of other languages within the host language more feasible.

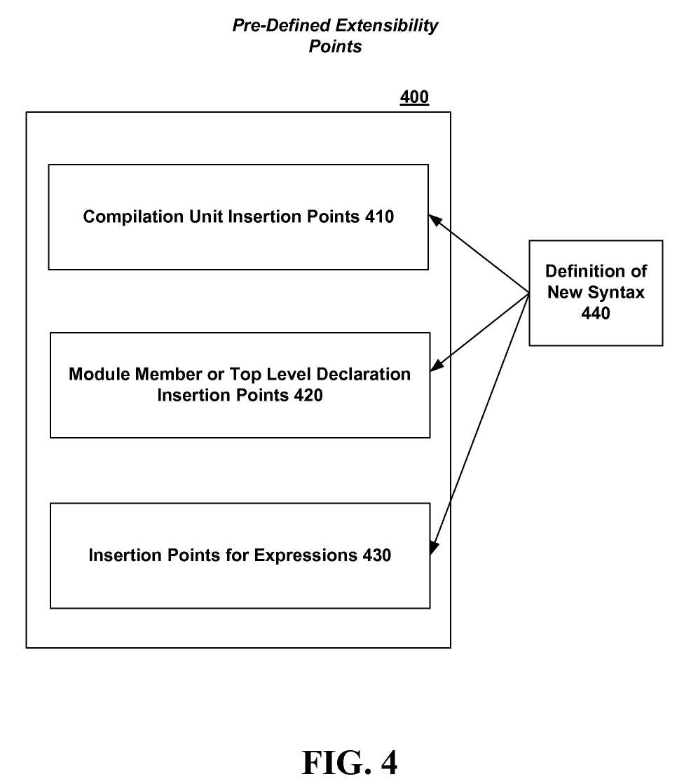

For instance, in one embodiment illustrated in FIG. 4, a program 400 written in a host programming language includes pre-defined extensibility points for the user to insert new syntax 440, including, but not limited to compilation unit insertion points 410, module member or top level declaration insertion points 420 and insertion points for expressions 430. Syntax definitions thus slot into a host syntax by contributing to the host syntax in places that are explicitly designated for this purpose in the host syntax. As mentioned, examples include: CompilationUnit, ModuleMemberDeclaration, and Expression. Syntax definitions are thus applied/used in limited contexts, controlled by the syntactic categories of the host definition to which they contributed.

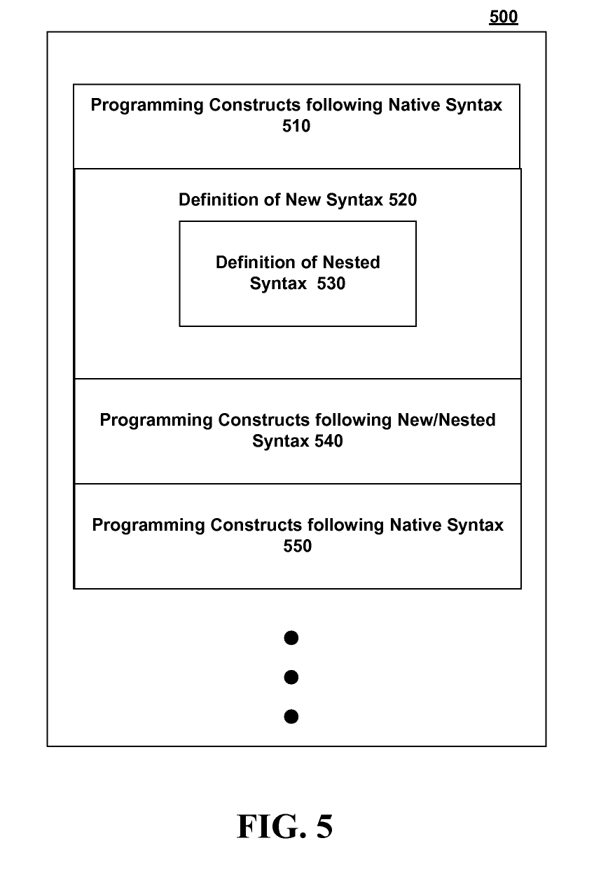

In another embodiment illustrated in FIG. 5, a program 500 includes programming constructs following the native syntax 510 and then a definition of a new syntax 520. In this regard, the new syntax 520 itself extends itself to another domain via nested syntax 530. In this respect, while a simple nested relationship is illustrated, the resolution of rules and syntax for extending the syntax of the native language can be achieved via any hierarchical relationship of languages. Then, various constructs 540, 550 may appear in program 500 either according to the rules of the new/nested syntax 540 implicating two (or more) different new languages or according to rules of the host language syntax 550.

Thus, syntax definitions are themselves extensible if they build on, and thus re-expose, extensible definitions from their host syntax or when they have explicitly designated extensibility points themselves. An example would be if a custom syntax builds on an Expression and therefore can accept nested use of extension syntaxes that contribute to Expression.

Syntax definitions can also be scoped to enclosing definitions, for example, types, such that any application/use of that enclosing definition enables the nested use of the extended syntax.

```
    type Point { x : Integer32; y : Integer32; } with syntax ‘(’
x:Expression ‘,’ y:Expression ‘)’ => { x, y };
    Points : Point*;
    Points { (1, 2), (2, 4), (3, 8) }
```

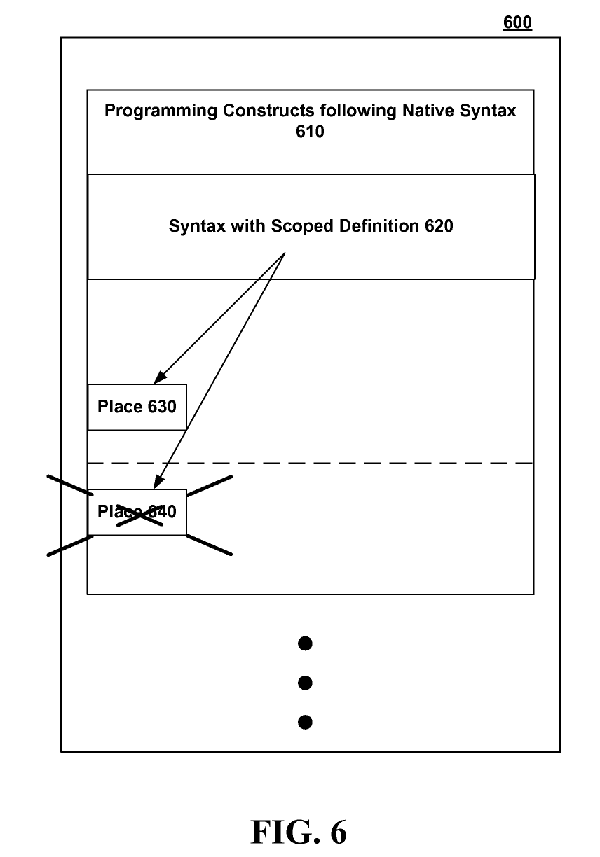

This is illustrated conceptually in FIG. 6 where a program 600 with programming constructs in the native language 610 include a new syntax with a scoped definition which means, functionally, the scope or reach of the new syntax is limited to places 630, but not places 640. For instance, in the above example, the new Point language can be used with values of type Point, however, the new syntax cannot be used for a type Coordinate, or any other construct. Rather, the syntax is limited to the expression for which it extends the syntax.

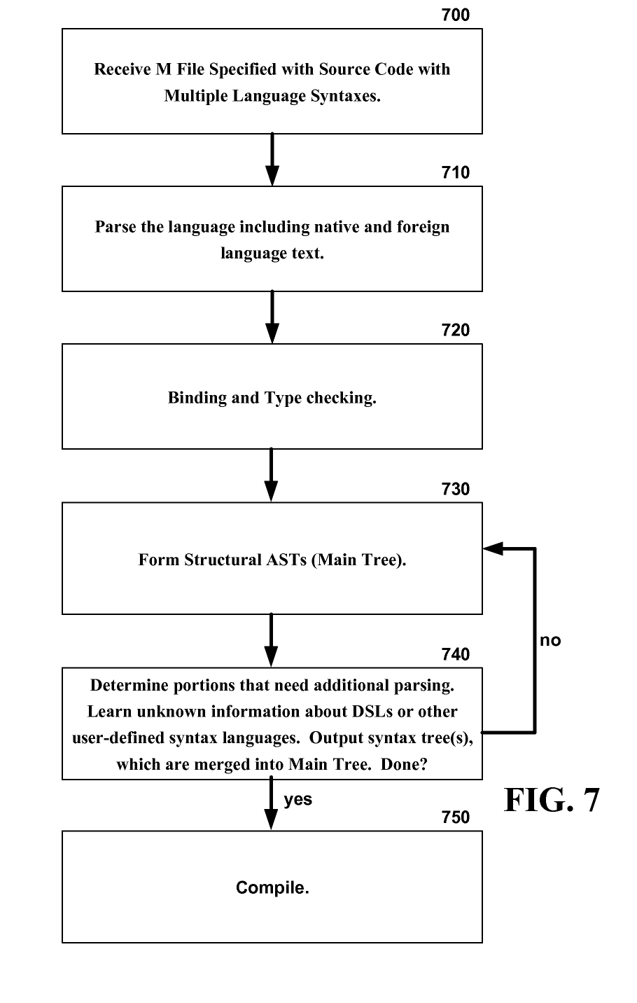

FIG. 7 is illustrative of a process for compiling a program with multiple language definitions and usage of syntax. At 700, an M file is specified with source code with multiple language syntaxes. At 710, the program is parsed a first time with respect to the native language, in effect, noting where the foreign language constructs are to gather additional information, first constructing and then refining an Mgraph. While inexact, an analogy might be drawn to English prose containing foreign language words. One would first read the English, and make note that there are some unknown foreign language words, and then a dictionary contained elsewhere in the prose could be used to later resolve the meaning the foreign language words, once identified.

At 720, a simplified form of binding and type checking takes place over the understood or known constructs in the program, with the output being a set of structural abstract syntax trees (ASTs) at 730. At 740, the unknown portions of the tree that need additional parsing work are identified, and the compiler performs additional parsing for these based on the language specification and syntax. The output of this step is again syntax trees which are merged into the main tree formed at 730. Once all foreign constructs, which may be nested so as to require multiple passes over the tree to determine syntactical meaning, are resolved, the result is an M semantic graph structure that is compiled according to typical compilation steps that follow.

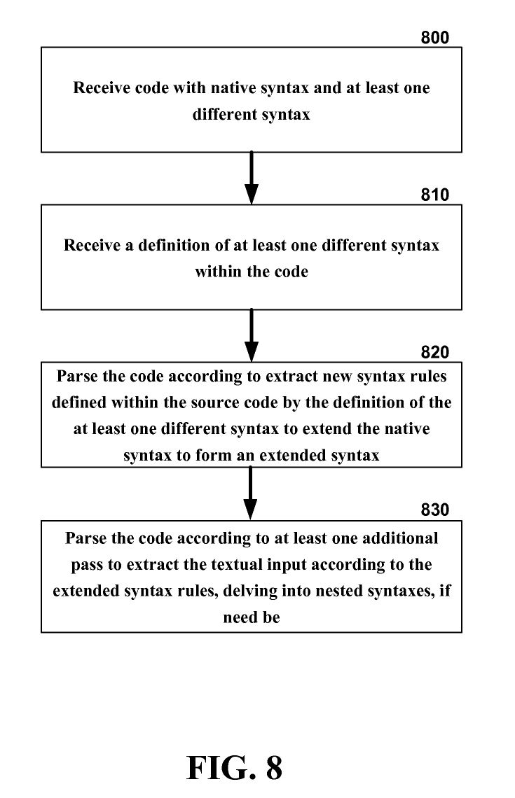

FIG. 8 is a flow diagram of a representative process for generating object code from source code in one or more embodiments. At 800 and 810, code is received with native syntax, at least one different syntax, and a definition of at least one different syntax within the code. At 820, the code is parsed according to extract new syntax rules defined within the source code by the definition of the at least one different syntax to extend the native syntax to form an extended syntax. At 830, the code is parsed according to at least one additional pass to extract the textual input according to the extended syntax rules, delving into nested syntaxes, if need be.

For an example of the above concepts, consider the following program where Lines 000-058 constitute the entire program written in the M programming language.

000 // Rules example with quoted expressions, no macros and no domain
syntax
001
002 module Rules {
003
004 RuleSets {
005 CalculateItemTotals {
006 Name = “CalculateItemTotals”,
007 Chaining = Chaining.Full,
008
009 .Rules {
010 {
011 RuleSet = RuleSets.CalculateItemTotals
012 Name = “CalcTotal”,
013 Condtion = [SalesItem.OrderTotal > 10],
014 Then = [SalesItem.OrderTotal = SalesItem.Quantity *
015 (SalesItem.ItemPrice * 0.95) ],
016 Else = [SalesItem.OrderTotal = SalesItem.Quantity *
SalesItem.ItemPrice]
017 },
018 {
019 RuleSet = RuleSets.CalculteItemTotals,
020 Name = “CalcShipping”,
021 Condition = [SalesItem.OrderTotal > 100.0],
022 Then = [SalesItem.Shipping = 0;],
023 Else = [SalesItem.Shipping = SalesItem.Quantity * 0.95]
024 },
025 {
026 RuleSet = RuleSets.CalculteItemTotals,
027 Name = “NewCustomer”,
028 Condition = [SalesItem.IsNewCustomer],
029 Then = [SalesItem.OrderTotal =
SalesItem.OrderTotal − 10.0]
030 },
031 }
032 }
033 }
034
035 Chaining {Full = “Full”, Partial = “Partial”}
036
037 type RuleSet {
038 Id : Integer32 = AutoNumber( );
039 Name : Text;
040 Chaining : Chaining;
041 } where identity Id;
042
043 RuleSets : RuleSet*;
044
045 type Rule {
046 Id : Integer32 = AutoNumber( );
047 Name : Text;
048 RuleSet : RuleSet;
049 Condition : Expression;
050 Then : Expression;
051 Else : Expression?;
052 } where identity Id;
053
054 Rules : Rule* where
055 Condition in Expressions,
056 Then in Expressions,
057 Else in Expressions;
058 }

In this example above, there is no domain specific syntax. Lines 037-057 define data structures and lines 004-035 define data values, which conform to those structures. One point to note is the square brackets [ ] denote expressions to be parsed and stored as expressions.

As mentioned, the above program contains no domain specific syntax. For ease of comparison, the following is a program in the same language with syntax extensions according to one or more embodiments herein, where lines 001-076 define the whole program.

000
001 module Rules {
002
003 RuleSets {
004 ruleset CalculateItemTotals {
005 Chaning = Full;
006
007 rule CalcTotal(SalesItem.OrderTotal > 10)
008 SalesItem.OrderTotal = SalesItem.Quantity *
(SalesItem.ItemPrice * 0.95)
009 else
010 SalesItem.OrderTotal SalesItem.Quantity *
SalesItem.ItemPrice;
011
012 rule CalcShipping(SalesItem.OrderTotal > 100.0)
013 SalesItem.Shipping = 0;
014 else
015 SalesItem.Shipping = SalesItem.Quantity * 0.95;
016
017 rule NewCustomer(SalesItem.IsNewCustomer)
018 SalesItem.OrderTotal = SalesItem.OrderTotal − 10.0;
019 }
020 }
021 syntax Rule =
022 “rule” name:Identifier “(” condition:Expression “)”
action:Expression “;” =>
023 [
024 name {
025 Name = name,
026 Condition = condition,
027 Then = action
028 }
029 ]
030 | “rule” name:Identifier “(” condition:Expression “)”
action:Expression “;” “else” alternative “;” =>
031 [
032 {
033 Name = name,
034 Condition = condition,
035 Then = action
036 Else = alternative
037 }
038 ]
039 ;
040
041 syntax RuleSet =
042 “ruleset” name:Identifier “{” “Chaining” “=”
chaining:Identifier “;” rules:Rule* “}” =>
043 [
044 name {
045 Name = name,
046 Chanining = chaining,
047 .Rules rules
048 }
049 ]
050 ;
051
052 syntax Declaration |= Ruleset;
053
054 type RuleSet {
055 Id : Integer32 = AutoNumber( );
056 Name : Text;
057 Chaining : Chaining;
058 } where identity Id;
059
060 RuleSets : RuleSet*;
061
062 type Rule {
063 Id : Integer32 = AutoNumber( );
064 Name : Text;
065 RuleSet : RuleSet;
066 Condition : Expression;
067 Then : Expression;
068 Else : Expression?;
069 } where identity Id;
070
071
072 Rules : Rule* where
073 Condition in Expressions,
074 Then in Expressions,
075 Else in Expressions;
076 }

In the above program, lines 054-075 define data structures as the first example and lines 003-020 define data values in domain syntax. Lines 021-050 define terminology and grammar rules specific to this domain, which coincidentally uses the term “rule”. The syntax declarations translate the text specific to the domain to the exact structures required by the programming language. Line 052, in turn, adds the domain rules to the rules of the programming language. Specifically the domain rules extend the Declaration rule of the programming language.

In this example, the first phase of the compiler scans the file and extracts syntax declarations. Each syntax declaration begins with “syntax” and ends with “;”. All other text is ignored. Once these syntax declarations are processed and added to the parser, the file is parsed again and all the text is recognized. In this second pass, the syntax declarations are ignored and the domain specific syntax (e.g. “rule”, “ruleset”) is converted to data values which conform to the terminology and grammatical rules of the host programming language.

Another example of host programming language using another language within the program itself is the following module M first defining the data using foreign language A, then defining language A, and then defining some types that apply to the program and are based in part on language A.

```
Module M {
//
// The data...
//
Applications using A {|
    Application PersonApp
        With AutoView
        With AutoService|
        Use Model System.Identity.Parties As Parties
            With Controller AddFriend As BFF
        Use Model System.Identity.Friendships As Friendships
    End Application
|}
//
// The language...
//
Language A {|
    token Whitespace = (‘ “ | ‘\r’ | ‘\n’);
    token Integer = (‘0’..’9’)+;
    token Identifier = (‘A’..’Z’ | ‘a’..’z’ | ‘.’)+ − (As | End | Use | With
    interleave Skippable = Whitespace;
    syntax Main = apps:App* => apps;
    syntax App = “Application” name:Identifier autoview:AutoView?
        autoservice => { Name { name }, autoview, autoservice,
        Models { modelref } };
    syntax AutoView = “With” “AutoView”
        => AutoView { true };
    syntax AutoService = “With” “AutoService”
        => AutoService { true };
    syntax ModelRef = “Use” “Model” sourcename:Identifier “As”
    name:Identifier
        => { SourceName { sourcename }, Name { name },
    Controllers { controllers };
    syntax ControllerRef = “Use” “Controller” sourcename:Identifier
    “As” name:Identifier
        => { SourceName { sourcename }, Name { name } };
    @{Classification[“Keyword”]} token As = “As”;
    @{Classification[“Keyword”]} token End = “End”;
    @{Classification[“Keyword”]} token Use = “Use”;
    @{Classification[“Keyword”]} token With = “With”;
    @{Classification[“Keyword”]} token Application = “Application”;
    @{Classification[“Keyword”]} token Model = “Model”;
    @{Classification[“Keyword”]} token Controller = “Controller”;
|}
//
// The schema...
//
Type Application {
    Id : Integer32 = AutoNumber( );
    AutoService : Logical = false;
    AutoView : Logical = false;
    Name : Text;
    Model : Model*;
} where identity Id;
Applications : Application* where item.Models <= Models;
Type Model {
    Id : Integer32 = AutoNumber( )
    Name : Text;
    SourceName : Text;
    Controllers : Controller*;
} where identity Id;
Models : Model* where item.Controllers <= M.Controllers;
Type Controller {
    Id : Integer32 = AutoNumber( );
    Name : Text;
    SourceName : Text;
} where identity Id;
Controllers : Controller*;
}
```

The language A is then an example of a syntax extension that contributes to CompilationUnit and that, presumably, does not use any of the M syntactic categories beyond, perhaps, scalar expressions.

### Exemplary Declarative Programming Language

For the avoidance of doubt, the additional context provided in this subsection regarding a declarative programming language, such as the M programming language, is to be considered non-exhaustive and non-limiting. The particular example snippets of pseudo-code set forth below are for illustrative and explanatory purposes only, and are not to be considered limiting on the embodiments of the extensible syntax for a declarative programming language described above in various detail.

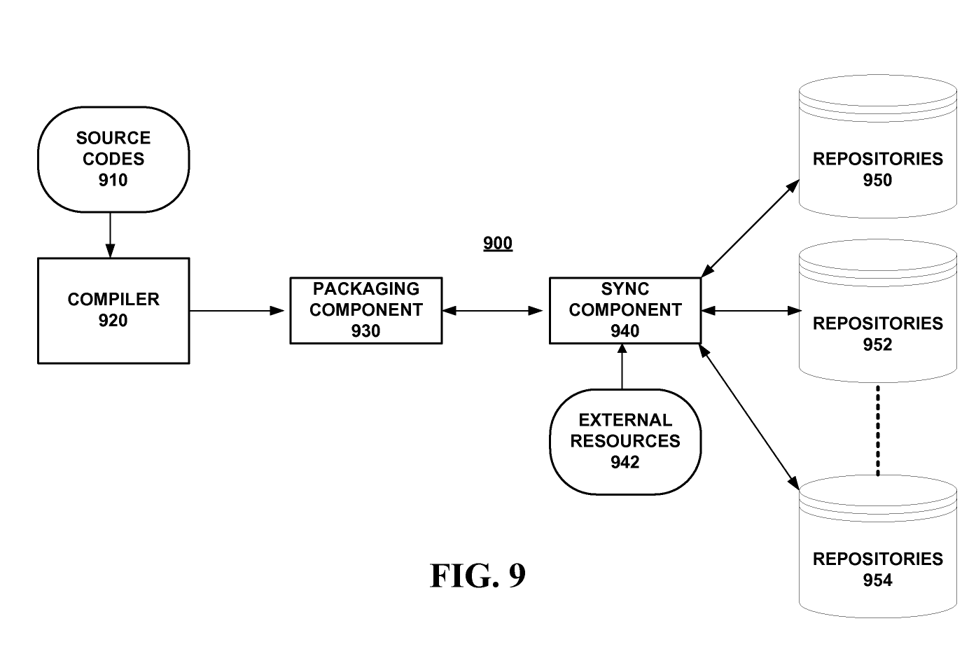

In FIG. 9, an exemplary process chain for a declarative model is provided, such as a model based on the M programming language. As illustrated, process chain 900 may include a coupling of compiler 920, packaging component 930, synchronization component 940, and a plurality of repositories 950, 952, . . . , 954. Within such embodiment, a source code 910 input to compiler 920 represents a declarative execution model authored in a declarative programming language, such as the M programming language. With the M programming language, for instance, the execution model embodied by source code 910 advantageously follows constraint-based typing, or structural typing, and/or advantageously embodies an order-independent or unordered execution model to simplify the development of code.

Compiler 920 processes source codes 910 and can generate a post-processed definition for each source code. Although other systems perform compilation down to an imperative format, the declarative format of the source code, while transformed, is preserved. Packaging component 930 packages the post-processed definitions as image files, such as M_Image files in the case of the M programming language, which are installable into particular repositories 950, 952, . . . , 954. Image files include definitions of necessary metadata and extensible storage to store multiple transformed artifacts together with their declarative source model. For example, packaging component 930 may set particular metadata properties and store the declarative source definition together with compiler output artifacts as content parts in an image file.

With the M programming language, the packaging format employed by packaging component 930 is conformable with the ECMA Open Packaging Conventions (OPC) standards. One of ordinary skill would readily appreciate that this standard intrinsically offers features like compression, grouping, signing, and the like. This standard also defines a public programming model (API), which allows an image file to be manipulated via standard programming tools. For example, in the .NET Framework, the API is defined within the “System.IO.Packaging” namespace.

Synchronization component 940 is a tool that can be used to manage image files. For example, synchronization component 940 may take an image file as an input and link it with a set of referenced image files. In between or afterwards, there could be several supporting tools (like re-writers, optimizers, etc.) operating over the image file by extracting packaged artifacts, processing them and adding more artifacts in the same image file. These tools may also manipulate some metadata of the image file to change the state of the image file, e.g., digitally signing an image file to ensure its integrity and security.

Next, a deployment utility deploys the image file and an installation tool installs it into a running execution environment within repositories 950, 952, . . . , 954. Once an image file is deployed, it may be subject to various post deployment tasks including export, discovery, servicing, versioning, uninstall and more. With the M programming language, the packaging format offers support for all these operations while still meeting enterprise-level industry requirements like security, extensibility, scalability and performance. In one embodiment, repositories 950 can be a collection of relational database management systems (RDBMS), however any storage can be accommodated.

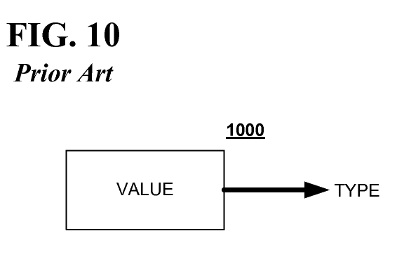

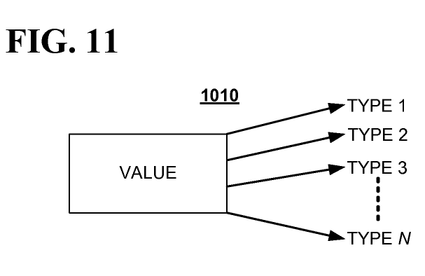

In one embodiment, the methods described herein are operable with a programming language having a constraint-based type system. Such a constraint-based system provides functionality not simply available with traditional, nominal type systems. In FIGS. 10-11, a nominally typed execution system is compared to a constraint-based typed execution system according to an embodiment of the invention. As illustrated, the nominal system 1000 assigns a particular type for every value, whereas values in constraint-based system 1010 may conform with any of an infinite number of types.

For an illustration of the contrast between a nominally-typed execution model and a constraint-based typed model according to a declarative programming language described herein, such as the D programming language, exemplary code for type declarations of each model are compared below.

First, with respect to a nominally-typed execution model the following exemplary C# code is illustrative:

```
class A
{
    public string Bar;
    public int Foo;
}
class B
{
    public string Bar;
    public int Foo;
}
```

For this declaration, a rigid type-value relationship exists in which A and B values are considered incomparable even if the values of their fields, Bar and Foo, are identical. In contrast, with respect to a constraint-based model, the following exemplary D code (discussed in more detail below) is illustrative of how objects can conform to a number of types:

type A { Bar : Text; Foo : Integer; }
type B { Bar : Text; Foo : Integer; }

For this declaration, the type-value relationship is much more flexible as all values that conform to type A also conform to B, and vice-versa. Moreover, types in a constraint-based model may be layered on top of each other, which provides flexibility that can be useful, e.g., for programming across various RDBMSs. Indeed, because types in a constraint-based model initially include all values in the universe, a particular value is conformable with all types in which the value does not violate a constraint codified in the type's declaration. The set of values conformable with type defined by the declaration type T:Text where value <128 thus includes “all values in the universe” that do not violate the “Integer” constraint or the “value <128” constraint.

Thus, in one embodiment, the programming language of the source code is a purely declarative language that includes a constraint-based type system as described above, such as implemented in the M programming language.

In another embodiment, the method described herein is also operable with a programming language having an order-independent, or unordered, execution model. Similar to the above described constraint-based execution model, such an order-independent execution model provides flexibility that can be useful, e.g., for programming across various RDBMSs.

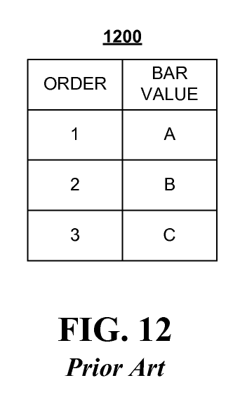

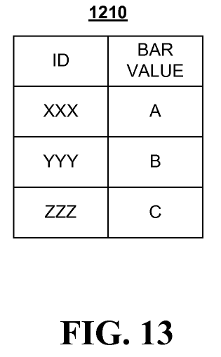

In FIGS. 12-13, for illustrative purposes, a data storage abstraction according to an ordered execution model is compared to a data storage abstraction according to an order-independent execution model. For example, data storage abstraction 1200 of FIG. 12 represents a list Foo created according to an ordered execution model, whereas data abstraction 1210 of FIG. 13 represents a similar list Foo created by an order-independent execution model.

As illustrated, each of data storage abstractions 1200 and 1210 include a set of three Bar values (i.e., “1”, “2”, and “3”). However, data storage abstraction 1200 requires these Bar values to be entered/listed in a particular order, whereas data storage abstraction 1210 has no such requirement. Instead, data storage abstraction 1210 simply assigns an ID to each Bar value, wherein the order that these Bar values were entered/listed is unobservable to the targeted repository. For instance, data storage abstraction 1210 may have thus resulted from the following order-independent code:

f: Foo* = {Bar = “1”};
f: Foo* = {Bar = “2”};
f: Foo* = {Bar = “3”};

However, data storage abstraction 1210 may have also resulted from the following code:

f: Foo* = {Bar = “3”};
f: Foo* = {Bar = “1”};
f: Foo* = {Bar = “2”};

And each of the two codes above are functionally equivalent to the following code:

f: Foot={{Bar =“2”}, {Bar=“3”}, {Bar =“1”}};

An exemplary declarative language that is compatible with the above described constraint based typing and unordered execution model is the M programming language, sometimes referred to herein as “M” for convenience, which was developed by the assignee of the present invention. However, in addition to M, it is to be understood that other similar declarative programming languages may be used, and that the utility of the invention is not limited to any single programming language, where any one or more of the embodiments of the directed graph structures described above apply. In this regard, some additional context regarding M is provided below.

As mentioned, M is a declarative language for working with data. M lets users determine how they want to structure and query their data using a convenient textual syntax that is both authorable and readable. In one non-limiting aspect, an M program includes of one or more source files, known formally as compilation units, wherein the source file is an ordered sequence of Unicode characters. Source files typically have a one-to-one correspondence with files in a file system, but this correspondence is not required. For maximal portability, it is recommended that files in a file system be encoded with the UTF-8 encoding.

Conceptually speaking, an M program is compiled using four steps: 1) Lexical analysis, which translates a stream of Unicode input characters into a stream of tokens (Lexical analysis evaluates and executes preprocessing directives); 2) Syntactic analysis, which translates the stream of tokens into an abstract syntax tree; 3) Semantic analysis, which resolves all symbols in the abstract syntax tree, type checks the structure and generates a semantic graph; and 4) Code generation, which generates executable instructions from the semantic graph for some target runtime (e.g. SQL, producing an image). Further tools may link images and load them into a runtime.

As a declarative language, M does not mandate how data is stored or accessed, nor does it mandate a specific implementation technology (in contrast to a domain specific language such as XAML). Rather, M was designed to allow users to write down what they want from their data without having to specify how those desires are met against a given technology or platform. That stated, M in no way prohibits implementations from providing rich declarative or imperative support for controlling how M constructs are represented and executed in a given environment, and thus, enables rich development flexibility.

M builds on three basic concepts: values, types, and extents. These three concepts can be defined as follows: 1) a value is data that conforms to the rules of the M language, 2) a type describes a set of values, and 3) an extent provides dynamic storage for values.

In general, M separates the typing of data from the storage/extent of the data. A given type can be used to describe data from multiple extents as well as to describe the results of a calculation. This allows users to start writing down types first and decide where to put or calculate the corresponding values later.

On the topic of determining where to put values, the M language does not specify how an implementation maps a declared extent to an external store such as an RDBMS. However, M was designed to make such implementations possible and is compatible with the relational model.

With respect to data management, M is a functional language that does not have constructs for changing the contents of an extent, however, M anticipates that the contents of an extent can change via external (to M) stimuli and optionally, M can be modified to provide declarative constructs for updating data.

It is often desirable to write down how to categorize values for the purposes of validation or allocation. In M, values are categorized using types, wherein an M type describes a collection of acceptable or conformant values. Moreover, M types are used to constrain which values may appear in a particular context (e.g., an operand, a storage location).

With a few notable exceptions, M allows types to be used as collections. For example, the “in” operator can be used to test whether a value conforms to a given type, such as:

1 in Number
“Hello, world” in Text

It should be noted that the names of built-in types are available directly in the M language. New names for types, however, may also be introduced using type declarations. For example, the type declaration below introduces the type name “My Text” as a synonym for the “Text” simple type:
type [My Text] : Text;

With this type name now available, the following code may be written:

“Hello, world” in [My Text]

While it is useful to introduce custom names for an existing type, it is even more useful to apply a predicate to an underlying type, such as:

type SmallText: Text where value.Count<7;

In this example, the universe of possible “Text” values has been constrained to those in which the value contains less than seven characters. Accordingly, the following statements hold true for this type definition:

“Terse” in SmallText
!(“Verbose” in SmallText)

Type declarations compose:

type TinyText: SmallText where value.Count<6;

However, in this example, this declaration is equivalent to the following:

type TinyText: Text where value.Count<6;

It is noted that the name of the type exists so an M declaration or expression can refer to it. Any number of names can be assigned to the same type (e.g., Text where value.Count <7) and a given value either conforms to all of them or to none of them. For example, consider this example:

type A : Number where value < 100;
type B : Number where value < 100:

Given these two type definitions, both of the following expressions:

1 in A

1 in B

will evaluate to true. If the following third type is introduced:

type C:Number where value>0;

the following can be stated:

1 in C

A general principle of M is that a given value can conform to any number of types. This is a departure from the way many object-based systems work, in which a value is bound to a specific type at initialization-time and is a member of the finite set of subtypes that were specified when the type was defined.

Another type-related operation that bears discussion is the type ascription operator (:). The type ascription operator asserts that a given value conforms to a specific type.

In general, when values in expressions are seen, M has some notion of the expected type of that value based on the declared result type for the operator/function being applied. For example, the result of the logical “and” operator (&&) is declared to be conformant with type “Logical.”

It is occasionally useful (or even required) to apply additional constraints to a given value—typically to use that value in another context that has differing requirements. For example, consider the following type definition:

type SuperPositive:Number where value>5;

Assuming that there is a function named “CalcIt” that is declared to accept a value of type “SuperPositive” as an operand, it is desirable to allow expressions like this in M:

CalcIt(20)

CalcIt(42+99)

and prohibit expressions like this:

CalcIt(−1)

CalcIt(4)

In fact, M does exactly what is wanted for these four examples. This is because these expressions express their operands in terms of built-in operators over constants. All of the information needed to determine the validity of the expressions is readily available the moment the M source text for the expression is encountered at little cost.

However, if the expression draws upon dynamic sources of data and/or user-defined functions, the type ascription operator is used to assert that a value will conform to a given type.

To understand how the type ascription operator works with values, a second function, “GetVowelCount,” is assumed that is declared to accept an operand of type “Text” and return a value of type “Number” that indicates the number of vowels in the operand.

Since it is unknown based on the declaration of “GetVowelCount” whether its results will be greater than five or not, the following expression is thus not a legal M expression:

CalcIt(GetVowelCount(someTextVariable))

The expression is not legal because the declared result type (Number) of “GetVowelCount” includes values that do not conform to the declared operand type of “CalcIt” (SuperPositive). This expression can be presumed to have been written in error.

However, this expression can be rewritten to the following (legal) expression using the type ascription operator:

CalcIt((GetVowelCount(someTextVariable):SuperPositive))

By this expression, M is informed that there is enough understanding of the “GetVowelCount” function to know that a value that conforms to the type “SuperPositive” will be obtained. In short, the programmer is telling M that he/she knows what M is doing.

However, if the programmer does not know, e.g., if the programmer misjudged how the “GetVowelCount” function works, a particular evaluation may result in a negative number. Because the “CalcIt” function was declared to only accept values that conform to “SuperPositive,” the system will ensure that all values passed to it are greater than five. To ensure this constraint is never violated, the system may inject a dynamic constraint test that has a potential to fail when evaluated. This failure will not occur when the M source text is first processed (as was the case with CalcIt(−1))—rather it will occur when the expression is actually evaluated.

In this regard, M implementations typically attempt to report any constraint violations before the first expression in an M document is evaluated. This is called static enforcement and implementations will manifest this much like a syntax error. However, some constraints can only be enforced against live data and therefore require dynamic enforcement.

In this respect, M make it easy for users to write down their intention and put the burden on the M implementation to “make it work.” Optionally, to allow a particular M document to be used in diverse environments, a fully featured M implementation can be configurable to reject M documents that rely on dynamic enforcement for correctness in order to reduce the performance and operational costs of dynamic constraint violations.

For further background regard, M, a type constructor can be defined for specifying collection types. The collection type constructor restricts the type and count of elements a collection may contain. All collection types are restrictions over the intrinsic type “Collection,” e.g., all collection values conform to the following expressions:

{ } in Collection
{ 1, false } in Collection
! (“Hello” in Collection)

The last example demonstrates that the collection types do not overlap with the simple types. There is no value that conforms to both a collection type and a simple type.

A collection type constructor specifies both the type of element and the acceptable element count. The element count is typically specified using one of the three operators.

| | |
|---|---|
| T* | zero or more Ts |
| T+ | one or more Ts |
| T#m . . . n | between m and n Ts. |

The collection type constructors can either use Kleene operators or be written longhand as a constraint over the intrinsic type Collection—that is, the following type declarations describe the same set of collection values:

type SomeNumbers: Number+;
type TwoToFourNumbers: Number#2 . . . 4;
type ThreeNumbers: Number#3;
type FourOrMoreNumbers: Number#4 . . . ;

These types describe the same sets of values as these longhand definitions:

```
type SomeNumbers: Collection where value.Count >= 1
          && item in Number;
type TwoToFourNumbers: Collection where value.Count >= 2
          && value.Count <= 4
          && item in Number;
type ThreeNumbers: Collection where value.Count == 3
          && item in Number;
type FourOrMoreNumbers: Collection where value.Count >= 4
          && item in Number;
```

Independent of which form is used to declare the types, the following expressions can be stated:

!({ } in TwoToFourNumbers)
!({ “One”, “Two”, “Three” } in TwoToFourNumbers)
{ 1, 2, 3 } in TwoToFourNumbers
{ 1, 2, 3 } in ThreeNumbers
{ 1, 2, 3, 4, 5 } in FourOrMoreNumbers

The collection type constructors compose with the “where” operator, allowing the following type check to succeed:

{1,2} in (Number where value <3)*where value.Count % 2==0

It is noted that the inner “where” operator applies to elements of the collection, and the outer “where” operator applies to the collection itself.

Just as collection type constructors can be used to specify what kinds of collections are valid in a given context, the same can be done for entities using entity types.

In this regard, an entity type declares the expected members for a set of entity values. The members of an entity type can be declared either as fields or as calculated values. The value of a field is stored; the value of a calculated value is computed. Entity types are restrictions over the Entity type, which is defined in the M standard library.

The following is a simple entity type:

type MyEntity:Language.Entity;

The type “MyEntity” does not declare any fields. In M, entity types are open in that entity values that conform to the type may contain fields whose names are not declared in the type. Thus, the following type test:

{X=100, Y=200} in MyEntity

will evaluate to true, as the “MyEntity” type says nothing about fields named X and Y.

Entity types can contain one or more field declarations. At a minimum, a field declaration states the name of the expected field, e.g.:

type Point {X; Y;}

This type definition describes the set of entities that contain at least fields named X and Y irrespective of the values of those fields, which means that the following type tests evaluate to true:

{ X = 100, Y = 200 } in Point
{ X = 100, Y = 200, Z = 300 } in Point // more fields than expected OK
! ({ X = 100 } in Point) // not enough fields - not OK
{ X = true, Y = “Hello, world” } in Point

The last example demonstrates that the “Point” type does not constrain the values of the X and Y fields, i.e., any value is allowed. A new type that constrains the values of X and Y to numeric values is illustrated as follows:

```
type NumericPoint {
  X : Number;
  Y : Number where value > 0;
}
```

It is noted that type ascription syntax is used to assert that the value of the X and Y fields should conform to the type “Number.” With this in place, the following expressions evaluate to true:

{ X = 100, Y = 200 } in NumericPoint
{ X = 100, Y = 200, Z = 300 } in NumericPoint
! ({ X = true, Y = “Hello, world” } in NumericPoint)
! ({ X = 0, Y = 0 } in NumericPoint)

As was seen in the discussion of simple types, the name of the type exists so that M declarations and expressions can refer to it. That is why both of the following type tests succeed:

{ X = 100, Y = 200 } in NumericPoint
{ X = 100, Y = 200 } in Point

even though the definitions of NumericPoint and Point are independent.

Fields in M are named units of storage that hold values. M allows the developer to initialize the value of a field as part of an entity initializer. However, M does not specify any mechanism for changing the value of a field once it is initialized. In M, it is assumed that any changes to field values happen outside the scope of M.

A field declaration can indicate that there is a default value for the field. Field declarations that have a default value do not require conformant entities to have a corresponding field specified (such field declarations are sometimes called optional fields). For example, with respect to the following type definition:

```
type Point3d {
  X : Number;
  Y : Number;
  Z = −1 : Number; // default value of negative one
}
```

Since the Z field has a default value, the following type test will succeed:

{X=100, Y=200} in Point3d

Moreover, if a type ascription operator is applied to the value as follows:

({X=100, Y=200}:Point3d)

then the Z field can be accessed as follows:

({X=100, Y=200}:Point3d).Z

in which case this expression will yield the value −1.

In another non-limiting aspect, if a field declaration does not have a corresponding default value, conformant entities must specify a value for that field. Default values are typically written down using the explicit syntax shown for the Z field of “Point3d.” If the type of a field is either nullable or a zero-to-many collection, then there is an implicit default value for the declaring field of null for optional and { } for the collection.

For example, considering the following type:

```
type PointND {
  X : Number;
  Y : Number;
  Z : Number?; // Z is optional
  BeyondZ : Number*; // BeyondZ is optional too
}
```

Then, again, the following type test will succeed:

{X=100, Y=200} in PointND

and ascribing the “PointND” to the value yields these defaults:

({ X = 100, Y = 200 } : PointND).Z == null
({ X = 100, Y = 200 } : PointND).BeyondZ == { }

The choice of using a zero-to-one collection vs. an explicit default value to model optional fields typically comes down to one of style.

Calculated values are named expressions whose values are calculated rather than stored. An example of a type that declares such a calculated value is:

```
type PointPlus {
  X : Number;
  Y : Number;
// a calculated value
  IsHigh( ) : Logical { Y > 0; }
}
```

Note that unlike field declarations, which end in a semicolon, calculated value declarations end with the expression surrounded by braces.

Like field declarations, a calculated value declaration may omit the type ascription, like this example:

```
type PointPlus {
  X : Number;
  Y : Number;
// a calculated value with no type ascription
  InMagicQuadrant( ) { IsHigh && X > 0; }
  IsHigh( ) : Logical { Y > 0; }
}
```

In another non-limiting aspect, when no type is explicitly ascribed to a calculated value, M can infer the type automatically based on the declared result type of the underlying expression. In this example, because the logical and operator used in the expression was declared as returning a “Logical,” the “InMagicQuadrant” calculated value also is ascribed to yield a “Logical” value.

The two calculated values defined and used above did not require any additional information to calculate their results other than the entity value itself. A calculated value may optionally declare a list of named parameters whose actual values must be specified when using the calculated value in an expression. The following is an example of a calculated value that requires parameters:

```
type PointPlus {
  X : Number;
  Y : Number;
  // a calculated value that requires a parameter
  WithinBounds(radius : Number) : Logical {
    X * X + Y * Y <= radius * radius;
  }
  InMagicQuadrant( ) { IsHigh && X > 0; }
  IsHigh( ) : Logical { Y > 0; }
}
```

To use this calculated value in an expression, one provides values for the two parameters as follows:

({X=100, Y=200}:PointPlus).WithinBounds(50)

When calculating the value of “WithinBounds,” M binds the value 50 to the symbol radius, which causes the “WithinBounds” calculated value to evaluate to false.

It is noted with M that both calculated values and default values for fields are part of the type definition, not part of the values that conform to the type. For example, considering these three type definitions:

```
type Point {
  X : Number;
  Y : Number;
}
type RichPoint {
  X : Number;
  Y : Number;
  Z = −1 : Number;
  IsHigh( ) : Logical { X < Y; }
}
type WeirdPoint {
  X : Number;
  Y : Number;
  Z = 42 : Number;
  IsHigh( ) : Logical { false; }
}
```

Since RichPoint and WeirdPoint only have two required fields (X and Y), the following can be stated:

{ X=1, Y=2 } in RichPoint
{ X=1, Y=2 } in WeirdPoint

However, the “IsHigh” calculated value is only available when one of these two types is ascribed to the entity value:

({ X=1, Y=2 } : RichPoint).IsHigh == true
({ X=1, Y=2 } : WeirdPoint).IsHigh == false

Because the calculated value is purely part of the type and not the value, when the ascription is chained, such as follows:

(({X=−1, Y=2}:RichPoint):WeirdPoint).IsHigh==false

then, the outer-most ascription determines which function is called.

A similar principle is at play with respect to how default values work. It is again noted the default value is part of the type, not the entity value. Thus, when the following expression is written:

({X=−1, Y=2}:RichPoint).Z==−1

the underlying entity value still only contains two field values (1 and 2 for X and Y, respectively). In this regard, where default values differ from calculated values, ascriptions are chained. For example, considering the following expression:

(({X=1, Y=2}:RichPoint):WeirdPoint).Z==−1

Since the “RichPoint” ascription is applied first, the resultant entity has a field named Z having a value of −1; however, there is no storage allocated for the value, i.e., it is part of the type's interpretation of the value. Accordingly, when the “WeirdPoint” ascription is applied, it is applied to the result of the first ascription, which does have a field named Z, so that value is used to specify the value for Z. The default value specified by “WeirdPoint” is thus not needed.

Like all types, a constraint may be applied to an entity type using the “where” operator. Consider the following M type definition:

```
type HighPoint {
  X : Number;
  Y : Number;
} where X < Y;
```

In this example, all values that conform to the type “HighPoint” are guaranteed to have an X value that is less than the Y value. That means that the following expressions:

{ X = 100, Y = 200 } in HighPoint
! ({ X = 300, Y = 200 } in HighPoint)

both evaluate to true.

Moreover, with respect to the following type definitions:

```
type Point {
  X : Number;
  Y : Number;
}
type Visual {
  Opacity : Number;
}
type VisualPoint {
  DotSize : Number;
} where value in Point && value in Visual;
```

the third type, “VisualPoint,” names the set of entity values that have at least the numeric fields X, Y, Opacity, and DotSize.

Since it is a common desire to factor member declarations into smaller pieces that can be composed, M also provides explicit syntax support for factoring. For instance, the “VisualPoint” type definition can be rewritten using that syntax:

type VisualPoint : Point, Visual {
DotSize : Number;
}

To be clear, this is shorthand for the long-hand definition above that used a constraint expression. Furthermore, both this shorthand definition and long-hand definition are equivalent to this even longer-hand definition:

```
type VisualPoint = {
  X : Number;
  Y : Number;
  Opacity : Number;
  DotSize : Number;
}
```

Again, the names of the types are just ways to refer to types - the values themselves have no record of the type names used to describe them.

M can also extend LINQ query comprehensions with several features to make authoring simple queries more concise. The keywords, “where” and “select” are available as binary infix operators. Also, indexers are automatically added to strongly typed collections. These features allow common queries to be authored more compactly as illustrated below.

As an example of where as an infix operator, the following query extracts people under 30 from a defined collection of “People”:

from p in People
where p.Age = 30
select p

An equivalent query can be written:

People where value.Age=30

The “where” operator takes a collection on the left and a Boolean expression on the right. The “where” operator introduces a keyword identifier value in to the scope of the Boolean expression that is bound to each member of the collection. The resulting collection contains the members for which the expression is true. Thus, the expression:

Collection where Expression

is equivalent to:

from value in Collection
where Expression
select value

The M compiler adds indexer members on collections with strongly typed elements. For the collection “People,” for instance, the compiler might add indexers for “First(Text),” “Last(Text),” and “Age(Number).”

Accordingly, the statement:

Collection.Field(Expression)

is equivalent to:

from value in Collection
where Field == Expression
select value

“Select” is also available as an infix operator. With respect to the following simple query:

from p in People
select p.First + p.Last

the “select” expression is computed over each member of the collection and returns the result. Using the infix “select” the query can be written equivalently as:

People select value.First +value.Last

The “select” operator takes a collection on the left and an arbitrary expression on the right. As with “where,” “select” introduces the keyword identifier value that ranges over each element in the collection. The “select” operator maps the expression over each element in the collection and returns the result. For another example, the statement:

Collection select Expression

is equivalent to the following:

from value in Collection
select Expression

A trivial use of the “select” operator is to extract a single field:

People select value.First

The compiler adds accessors to the collection so single fields can be extracted directly as “People.First” and “People.Last.”

To write a legal M document, all source text appears in the context of a module definition. A module defines a top-level namespace for any type names that are defined. A module also defines a scope for defining extents that will store actual values, as well as calculated values.

The following is a simple example of a module definition:

```
module Geometry {
  // declare a type
  type Point {
    X : Integer; Y : Integer;
  }
  // declare some extents
  Points : Point*;
  Origin : Point;
  // declare a calculated value
  TotalPointCount { Points.Count + 1; }
}
```

In this example, the module defines one type named “Geometry.Point.” This type describes what point values will look like, but does not define any locations where those values can be stored.

This example also includes two module-scoped fields (Points and Origin). Module-scoped field declarations are identical in syntax to those used in entity types. However, fields declared in an entity type simply name the potential for storage once an extent has been determined; in contrast, fields declared at module-scope name actual storage that must be mapped by an implementation in order to load and interpret the module.

In addition, modules can refer to declarations in other modules by using an import directive to name the module containing the referenced declarations. For a declaration to be referenced by other modules, the declaration is explicitly exported using an export directive.

For example, considering the following module:

```
module MyModule {
  import HerModule; // declares HerType
  export MyType1;
  export MyExtent1;
  type MyType1 : Logical*;
  type MyType2 : HerType;
  MyExtent1 : Number*;
  MyExtent2 : HerType;
}
```

It is noted that only “MyType1” and “MyExtent1” are visible to other modules, which makes the following definition of “HerModule” legal:

```
module HerModule {
  import MyModule; // declares MyType1 and MyExtent1
  export HerType;
  type HerType : Text where value.Count < 100;
  type Private : Number where !(value in MyExtent1);
  SomeStorage : MyType1;
}
```

As this example shows, modules may have circular dependencies.

The types of the M language are divided into two main categories: intrinsic types and derived types. An intrinsic type is a type that cannot be defined using M language constructs but rather is defined entirely in the M language specification. An intrinsic type may name at most one intrinsic type as its super-type as part of its specification. Values are an instance of exactly one intrinsic type, and conform to the specification of that one intrinsic type and all of its super types.

A derived type is a type whose definition is constructed in M source text using the type constructors that are provided in the language. A derived type is defined as a constraint over another type, which creates an explicit subtyping relationship. Values conform to any number of derived types simply by virtue of satisfying the derived type's constraint. There is no a priori affiliation between a value and a derived type—rather a given value that conforms to a derived type's constraint may be interpreted as that type at will.

M offers a broad range of options in defining types. Any expression which returns a collection can be used as a type. The type predicates for entities and collections are expressions and fit this form. A type declaration may explicitly enumerate its members or be composed of other types.

Another distinction is between a structurally typed language, like M, and a nominally typed language. A type in M is a specification for a set of values. Two types are the same if the exact same collection of values conforms to both regardless of the name of the types. It is not required that a type be named to be used. A type expression is allowed wherever a type reference is required. Types in M are simply expressions that return collections.

Types are considered collections of all values that satisfy the type predicate. For that reason, any operation on a collection can be applied to a type and a type can be manipulated with expressions like any other collection value.

M provides two primary means for values to come into existence: calculated values and stored values (a.k.a. fields). Calculated and stored values may occur with both module and entity declarations and are scoped by their container. A computed value is derived from evaluating an expression that is typically defined as part of M source text. In contrast, a field stores a value and the contents of the field may change over time.

### Exemplary Networked and Distributed Environments

One of ordinary skill in the art can appreciate that the various embodiments for the extensible syntax for a declarative programming model described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may cooperate to perform one or more aspects of any of the various embodiments of the subject disclosure.

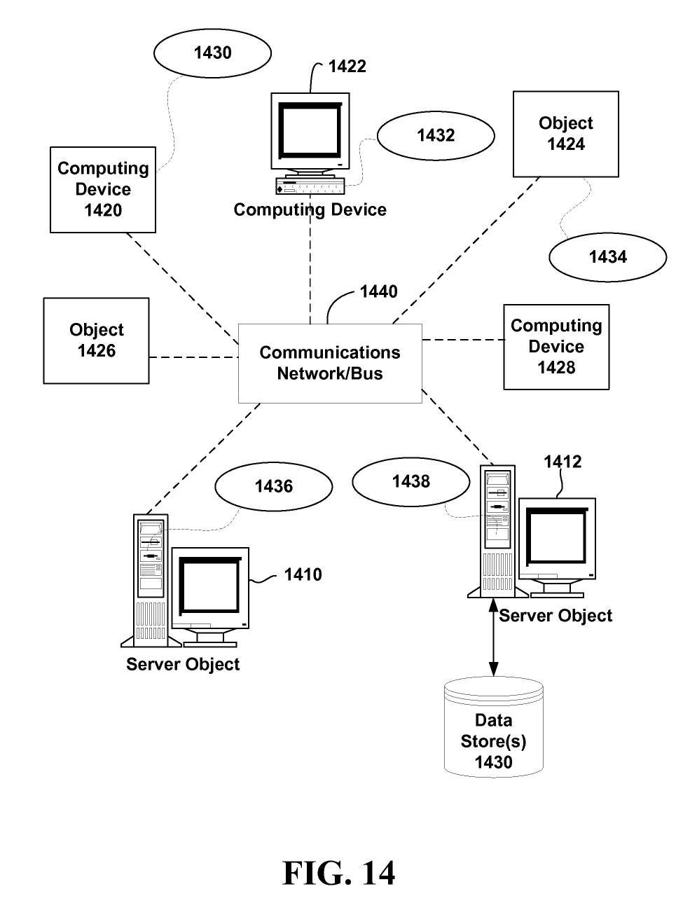

FIG. 14 provides a schematic diagram of an exemplary networked or distributed computing environment. The distributed computing environment comprises computing objects 1410, 1412, etc. and computing objects or devices 1420, 1422, 1424, 1426, 1428, etc., which may include programs, methods, data stores, programmable logic, etc., as represented by applications 1430, 1432, 1434, 1436, 1438. It can be appreciated that objects 1410, 1412, etc. and computing objects or devices 1420, 1422, 1424, 1426, 1428, etc. may comprise different devices, such as PDAs, audio/video devices, mobile phones, MP3 players, personal computers, laptops, etc.

Each object 1410, 1412, etc. and computing objects or devices 1420, 1422, 1424, 1426, 1428, etc. can communicate with one or more other objects 1410, 1412, etc. and computing objects or devices 1420, 1422, 1424, 1426, 1428, etc. by way of the communications network 1440, either directly or indirectly. Even though illustrated as a single element in FIG. 14, network 1440 may comprise other computing objects and computing devices that provide services to the system of FIG. 14, and/or may represent multiple interconnected networks, which are not shown. Each object 1410, 1412, etc. or 1420, 1422, 1424, 1426, 1428, etc. can also contain an application, such as applications 1430, 1432, 1434, 1436, 1438, that might make use of an API, or other object, software, firmware and/or hardware, suitable for communication with, processing for, or implementation of the extensible syntax for a data scripting language provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the extensible syntax for a data scripting language as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 14, as a non-limiting example, computers 1420, 1422, 1424, 1426, 1428, etc. can be thought of as clients and computers 1410, 1412, etc. can be thought of as servers where servers 1410, 1412, etc. provide data services, such as receiving data from client computers 1420, 1422, 1424, 1426, 1428, etc., storing of data, processing of data, transmitting data to client computers 1420, 1422, 1424, 1426, 1428, etc., although any computer can be considered a client, a server, or both, depending on the circumstances. Any of these computing devices may be processing data, encoding data, querying data or requesting services or tasks that may implicate the extensible syntax as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the extensible syntax for a data scripting language can be provided standalone, or distributed across multiple computing devices or objects.

In a network environment in which the communications network/bus 1440 is the Internet, for example, the servers 1410, 1412, etc. can be Web servers with which the clients 1420, 1422, 1424, 1426, 1428, etc. communicate via any of a number of known protocols, such as the hypertext transfer protocol (HTTP). Servers 1410, 1412, etc. may also serve as clients 1420, 1422, 1424, 1426, 1428, etc., as may be characteristic of a distributed computing environment.

### Exemplary Computing Device

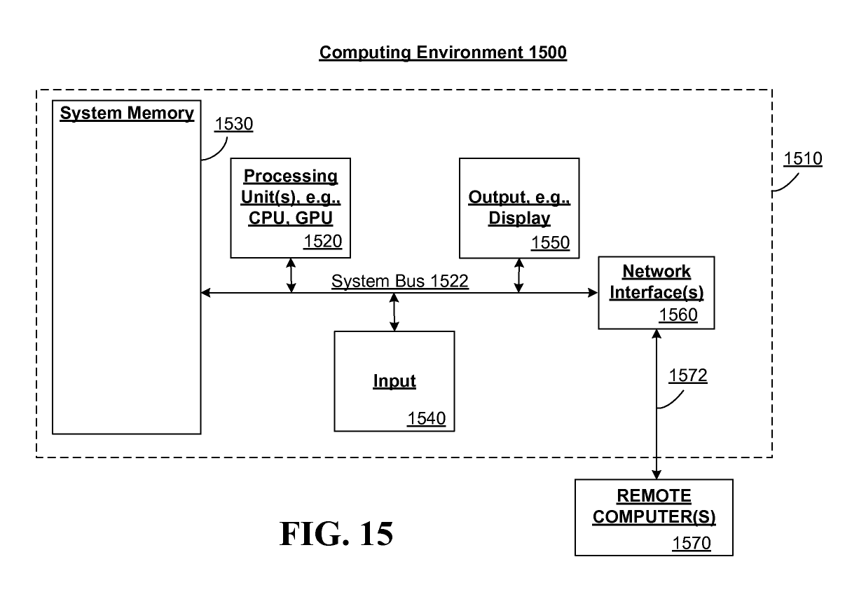

As mentioned, advantageously, the techniques described herein can be applied to any device where it is desirable to develop and execute data intensive applications, e.g., query large amounts of data quickly. It should be understood, therefore, that handheld, portable and other computing devices and computing objects of all kinds are contemplated for use in connection with the various embodiments, i.e., anywhere that a device may wish to scan or process huge amounts of data for fast and efficient results. Accordingly, the below general purpose remote computer described below in FIG. 15 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 15 thus illustrates an example of a suitable computing system environment 1500 in which one or aspects of the embodiments described herein can be implemented, although as made clear above, the computing system environment 1500 is only one example of a suitable computing environment and is not intended to suggest any limitation as to scope of use or functionality. Neither should the computing environment 1500 be interpreted as having any dependency or requirement relating to any one or combination of components illustrated in the exemplary operating environment 1500.

With reference to FIG. 15, an exemplary remote device for implementing one or more embodiments includes a general purpose computing device in the form of a computer 1510. Components of computer 1510 may include, but are not limited to, a processing unit 1520, a system memory 1530, and a system bus 1522 that couples various system components including the system memory to the processing unit 1520.

Computer 1510 typically includes a variety of computer readable media and can be any available media that can be accessed by computer 1510. The system memory 1530 may include computer storage media in the form of volatile and/or nonvolatile memory such as read only memory (ROM) and/or random access memory (RAM). By way of example, and not limitation, memory 1530 may also include an operating system, application programs, other program modules, and program data.

A user can enter commands and information into the computer 1510 through input devices 1540. A monitor or other type of display device is also connected to the system bus 1522 via an interface, such as output interface 1550. In addition to a monitor, computers can also include other peripheral output devices such as speakers and a printer, which may be connected through output interface 1550.

The computer 1510 may operate in a networked or distributed environment using logical connections to one or more other remote computers, such as remote computer 1570. The remote computer 1570 may be a personal computer, a server, a router, a network PC, a peer device or other common network node, or any other remote media consumption or transmission device, and may include any or all of the elements described above relative to the computer 1510. The logical connections depicted in FIG. 15 include a network 1572, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to develop and execute data intensive applications.

Also, there are multiple ways to implement the same or similar functionality, e.g., an appropriate API, tool kit, driver code, operating system, control, standalone or downloadable software object, etc. which enables applications and services to use the efficient encoding and querying techniques. Thus, embodiments herein are contemplated from the standpoint of an API (or other software object), as well as from a software or hardware object that provides or acts with respect to extensible syntax for a data scripting language. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A method for generating at least one programming module with a declarative programming language, including:
receiving, in memory of a computing device, textual input of a declarative source code including receiving, within the same program, native textual input specified according to a native syntax of the declarative programming language and foreign textual input specified according to a different syntax than the native syntax;
receiving, within the source code, a definition of the different syntax; and
compiling the source code including extending the rules of the native syntax with rules associated with the definition of the different syntax to form a set of extended syntax rules.

2. The method of claim 1, wherein the compiling includes converting the different syntax to data values that conform to the terminology and grammatical rules of the host programming language.

3. The method of claim 1, wherein the receiving, within the source code, a definition of the different syntax includes receiving, within the source code, a definition of a set of nested syntaxes.

4. The method of claim 1, wherein the receiving, within the source code, a definition of the different syntax includes receiving, within the source code, a definition of the different syntax that is scoped to enclosing definitions.

5. The method of claim 1, wherein the receiving, within the source code, a definition of the different syntax includes receiving, within the source code, a definition of the different syntax at one of a set of pre-fixed positions from a program function standpoint.

6. The method of claim 5, wherein the receiving, within the source code, a definition of the different syntax includes receiving, within the source code, a definition of the different syntax at a top level declaration, a module member declaration or an Expression.

7. The method of claim 1, wherein the compiling includes:
first parsing the source code according to a first pass in order to extract new syntax rules defined within the source code by the definition of the different syntax; and
second parsing the source code according to at least one additional pass to extract the textual input according to the extended syntax rules.

8. The method of claim 7, further including generating a semantic graph structure following the first parsing and merging abstract tree structures generated following the second parsing into the semantic graph structure.

9. The method of claim 7, wherein the first parsing includes scanning the source code and extracting at least one syntax declaration.

10. The method of claim 9, wherein the first parsing includes scanning the source code and extracting at least one declaration beginning with the keyword “syntax”.

11. The method of claim 7, wherein the second parsing includes ignoring syntax declarations.

12. A computer readable medium comprising computer executable instructions at least partially compiled from source code of a declarative programming language according to the method of claim 1.

13. A computer program product generated based on computer programming constructs of a declarative programming language, the computer program product generated from a method including:
receiving textual input of a declarative source code including, within the same data stream representing the source code, first textual input specified according to a first syntax of the declarative programming language, at least one definition of at least one second syntax different from the first syntax, and second textual input specified according to the at least one second syntax; and
compiling the textual input of the data stream to form the computer program product.

14. The computer program product of claim 13, wherein the receiving includes receiving the first textual input and the at least one definition of the at least one second syntax in the same expression of the declarative source code.

15. The computer program product of claim 13, wherein the receiving includes receiving the first textual input and the at least one definition of the at least one second syntax at a module level declaration of the declarative source code.

16. The computer program product of claim 13, wherein the compiling includes first parsing the data stream for constructs of the first syntax and identifying the at least one definition of the at least one second syntax and constructs of the at least one second syntax.

17. The computer program product of claim 16, wherein the compiling includes second parsing the data stream for constructs of the at least one second syntax based on the at least one definition identified.

18. A compiler comprising,
an interface for receiving textual input of a declarative source code including, within the same compilation unit, first textual input specified according to a native syntax of the declarative programming language, second textual input specified according to at least one syntax, each different from the native syntax and at least one definition of the at least one syntax located at permissible pre-determined positions within the source code; and
a parser that first parses over the first textual input to form a main tree structure and identifies the at least one definition and corresponding second textual input, and afterwards, parses over the second textual input based on the at least one definition and merges output of the parsing of the second textual input into the main tree structure.

19. The compiler of claim 18, wherein the parser forms a semantic graph structure following the first parsing over the first textual input and merges abstract tree structures, generated as output following the parsing of the second textual input, into the semantic graph structure.

20. The compiler of claim 18, wherein the parser scans the textual input of the declarative source code and extracts at least one syntax declaration including a definition of a set of nested syntaxes.
